(19) United States
(12) Patent Application Publication
(10) Pub. No.: US 2004/0127203 A1
(43) Pub. Date: Jul. 1, 2004

(54) Context sensitive call processing

(75) Inventors: Outi Markki, Espoo (FI); Dirk Trossen, Cambridge, MA (US)

Correspondence Address: BANNER & WITCOFF, 1001 G STREET N W, SUITE 1100, WASHINGTON, DC, 20001, US

(73) Assignee: Nokia, Inc., Irving, TX (US)

(21) Appl. No.: 10/329,996

(22) Filed: Dec. 26, 2002

(51) Int. Cl. H04Q 7/20

(52) U.S. Cl. 455/418; 455/445

(57) ABSTRACT

Systems and methods that extract application data from software applications and convert the application data to profile data formatted in accordance with a profile data syntax are disclosed. The common syntax allows several different software applications to be used during the processing of calls.

### BACKGROUND OF THE INVENTION

1. Field of the Invention

The invention relates to the processing of telephone calls. More particularly, the invention relates to the processing of incoming or outgoing calls based on current profile information and rules provided by a user.

2. Description of Related Art

Current mobile terminals provide a variety of mechanisms to alert users of incoming calls. The users can select the ringer type and volume and activate a voice mail service. The user may select how the mobile terminal responds to incoming calls. For example, while in a business meeting the user may program the mobile terminal to vibrate in response to incoming calls and while at a loud sporting event, the user may program the mobile terminal to increase the ringer volume level.

Current mobile terminals also include a variety of software applications. Some software applications allow users to document schedule information. Users typically review the status data stored with a schedule application and then manually program the response of the mobile terminal based on the schedule data.

One drawback of current mobile terminals is that they require users to manually program how the terminal will alert the users of new calls. Because of the variety of different formats used to store schedule data, it has not been feasible to configure mobile terminals to automatically adjust how they will alert users of incoming calls based on schedule data stored with the variety of scheduling applications that are stored in mobile terminals.

Therefore, there is a need in the art for systems and methods that allow mobile terminals that contain a variety of different applications to automatically adjust how the mobile terminals will alert users of incoming calls based on application data stored in the mobile terminal.

### BRIEF SUMMARY OF THE INVENTION

One or more of the above-mentioned needs in the art are satisfied by the disclosed systems and methods that extract application data from software applications and convert the application data to profile data formatted in accordance with a profile data syntax. The common syntax allows several different software applications to be used to control during the processing of calls.

In a first embodiment, a method of establishing call preference information for a mobile terminal is provided. The method includes extracting application data from at least one software application and converting the application data into profile data. The profile data is then transmitted to a context database.

In another embodiment of the invention, a mobile terminal configured to establish call preference information is provided. The mobile terminal includes an application module that creates application data and a context profile management module that converts the application data into profile data formatted in accordance with a profile data syntax.

In other embodiments of the invention, computer-executable instructions for implementing the disclosed methods are stored on computer-readable media.

### BRIEF DESCRIPTION OF THE DRAWINGS

The present invention is illustrated by way of example and not limited in the accompanying figures in which like reference numerals indicate similar elements and in which:

FIG. 1 shows a system for processing incoming and outgoing calls based on profile information and rules provided by a user;

FIG. 2 shows a configuration that illustrates how context profile management modules can be used to convert application data to profile data format in accordance with a profile data syntax, in accordance with an embodiment of the invention;

FIG. 3 illustrates a method that may be used by a mobile terminal to provide status data and profile data to a user context database, in accordance with an embodiment of the invention; and

FIG. 4 illustrates a method that may be used by a call processing server to process calls in accordance with an embodiment of the invention.

### DETAILED DESCRIPTION OF THE INVENTION

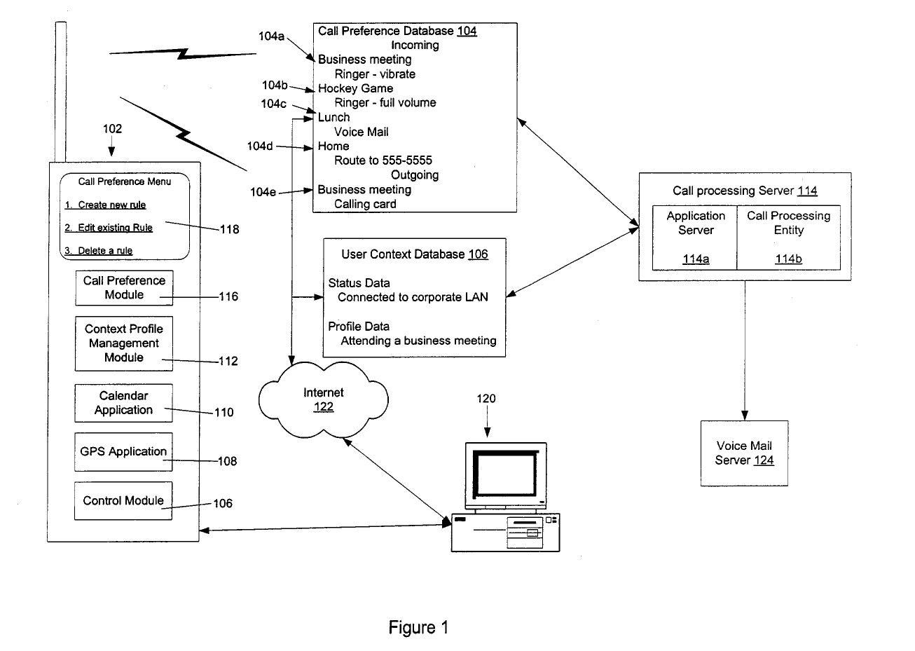

FIG. 1 shows a system for processing incoming or outgoing calls based on profile information and rules provided by a user. A mobile terminal 102 is shown coupled to a call preference database 104 and a user context database 106. Mobile terminal 102 may include a variety of different applications that may be used for purposes that include scheduling appointments and indicating the location of the mobile terminal. In the exemplary embodiment shown in FIG. 1, mobile terminal 102 includes a global positioning system (GPS) application 108 that may be used to identify the location of mobile terminal 102 in a conventional manner. A calendar application 110 may be used by a user to schedule meetings and other events. Calendar application 110 may be implemented with any of the conventional scheduling applications available on the market. A single calendar application 110 and a single GPS application 108 are shown for illustration purposes only. Mobile terminal 102 may include a variety of different calendar and scheduling applications as well as a variety of applications that provide location information. In one alternative embodiment of the invention, location information is determined based on the location of a cell station connected to mobile terminal 102.

A context profile management module 112 may be included to convert application data into profile data. The profile data may then be transmitted to user context database 106. Context profile management module may include software for converting the format of the application data into a common profile data syntax that may be recognized by user context database 106. For example, the profile data syntax may include a definition of “meeting.” The variety of available calendar and schedule applications may identify a meeting as a conference, meeting, seminar or use some other syntax. The variety of different formats have limited the ability of prior art systems to extract application data from the applications and directly use the data when processing calls. Context profile management module 112 may be used to convert a variety of different formats and descriptions into profile data formatted in accordance with the profile data syntax.

User context database 106 includes a profile data description of “attending a business meeting.” By way of example, calendar application 110 may list or identify the event as a “work conference” in the format that is not recognizable by a call processing server 114. Context profile management module 112 may be configured to receive the application data and reformat the data in accordance with the profile data syntax so that the information may be readily processed by call processing server 114. In the example shown, call processing server 114 is configured to recognize and know how to process profile data in the syntax of “attending a business meeting.”

Mobile terminal 102 may also include a call preference module 116 that may be used to establish one or more call preference rules. In the embodiment shown in FIG. 1 call preference rules are stored in call preference database 104. Of course there are a variety of different formats and languages that may be used to recite rules that will be used by call processing server 114. Rule 104a indicates that when the user is in a business meeting, an incoming call will be processed such that the ringer of mobile terminal 102 is set to vibrate mode. Rule 104b indicates that when the user is attending a hockey game, an incoming call is processed such that the ringer is increased to full volume. Rules may also be used to route calls away from mobile terminal 102. For example, rule 104c indicates that when the user is at lunch, an incoming call is processed by routing the call directly to voice mail. Rule 104d indicates that when the user is at home, an incoming call is processed by routing the call to a different telephone number. Rules might also be defined for outgoing calls. For instance, rule 104e routes outgoing calls during a business meeting via a calling card rather than using the normal subscription account. One skilled in the art will appreciate the invention is not limited to the rules or types of rules shown in call preference database 104 and that numerous different rules may be used to process calls based on profile data and/or status data.

In one embodiment, rules may be created with a graphical user interface 118 shown as part of mobile terminal 102. In an alternative embodiment, a workstation or other computer device may be used to provide rules to call preference database 104. Workstation 120 is shown coupled to call preference database 104 via the Internet 122. User context database 106 may also store status data. Status data may include the identification of a network coupled to mobile terminal 102, characteristics of the network coupled to mobile terminal 102 or any other information that may be used to assist in call processing decisions. For example, when mobile terminal 102 is connected to a wireless local area network calls may be transferred at a relatively high bit rate.

Call processing server 114 may include an application server 114a and a call processing entity 114b. Application server 114a may include hardware and/or software modules for retrieving status data and profile data from user context database 106 and any corresponding rules from call preference database 104 when processing a call. Call processing entity 114b may be implemented with a conventional device used to route calls. Call processing server 114 may be coupled to one or more voice mail servers, such as voice mail server 124.

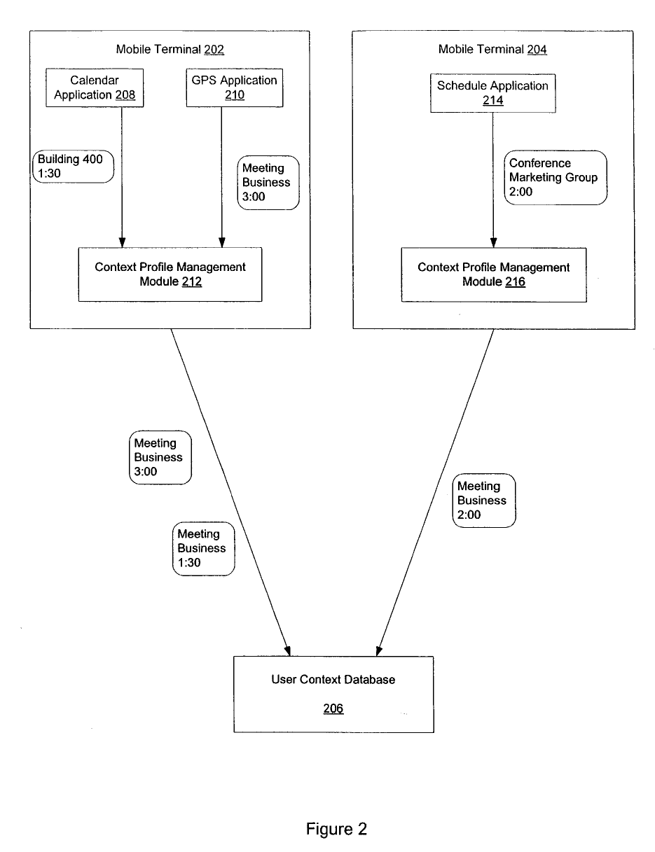

FIG. 2 shows a configuration that illustrates how context profile management modules can be used to convert application data to profile data format in accordance with a profile data syntax. Mobile terminals 202 and 204 are shown coupled to a user context database 206. Mobile terminal 202 includes a calendar application 208 and a GPS application 210. Both applications are coupled to context profile management module 212. Calendar application 208 transmits data to context profile management module 212 indicating that the user has a meeting scheduled in building 400 at 1:30. GPS application 210 transcends application data to context profile management module 212 indicating that the user is in a business meeting at 3:00. GPS application 210 may be configured to indicate that the user is a business meeting whenever the user is in a particular location. This feature may be used, for example, when there is a high correlation between a location and a particular activity.

Context profile management module 212 receives the application data and converts the data into profile data in accordance with a profile data syntax. As is shown in FIG. 2, the profile data transmitted from context profile management module 212 to user context database 206 is formatted in a common format.

Mobile terminals 204 may include a different application for scheduling events. In particular, schedule application 214 may format appointments in a format that is different from the format used by calendar application 208. Schedule application 214 transmits application data to a context profile management module 216 to indicate that the user will be in a conference with the marketing group at 2:00. Context profile management module 216 reformats the application data into profile data formatted in accordance with the profile data syntax. In particular, the characterization of the meeting as a “conference” is reformatted to “meeting” and the characterization of the conference being with the “marketing group” is reformatted to “business.” As is shown in FIG. 2, the three elements of profile data are formatted in accordance with a common profile data syntax. The common format facilitates processing by user context database 206 and call processing server 114 (shown in FIG. 1).

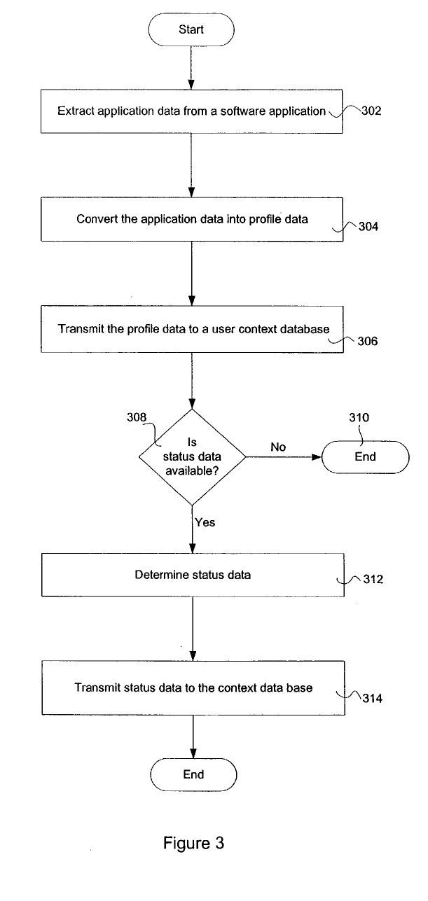

FIG. 3 illustrates a method that may be used by a mobile terminal to provide status data and profile data to a user context database 106. First, in step 302, application data is extracted from a software application. As has been described above, application data may be scheduled data, location data or other data that may be used to process calls. Step 302 may include a software application transmitting the application data to a context profile management module. Next, in step 304 the application data is converted into profile data. Step 304 may be performed by the context profile management module. In step 306 the profile data is transmitted to a user context database. In some embodiments the user context database may be remote to the mobile terminal. In other embodiments the user context database may be stored locally within a mobile terminal.

As described above, the user context database may also store status data. The status data may originate at the mobile terminal or another node in a network. When the status data originates with the mobile terminal, in step 308 it is determined whether status data is available. Step 308 may include identifying the network connection. When status data is not available, in step 310 the process terminates. When status data is available, in step 312 the status data is determined. Step 312 may include identifying the network and/or characteristics of the network. Finally, in step 314 the status data is transmitted to the context database.

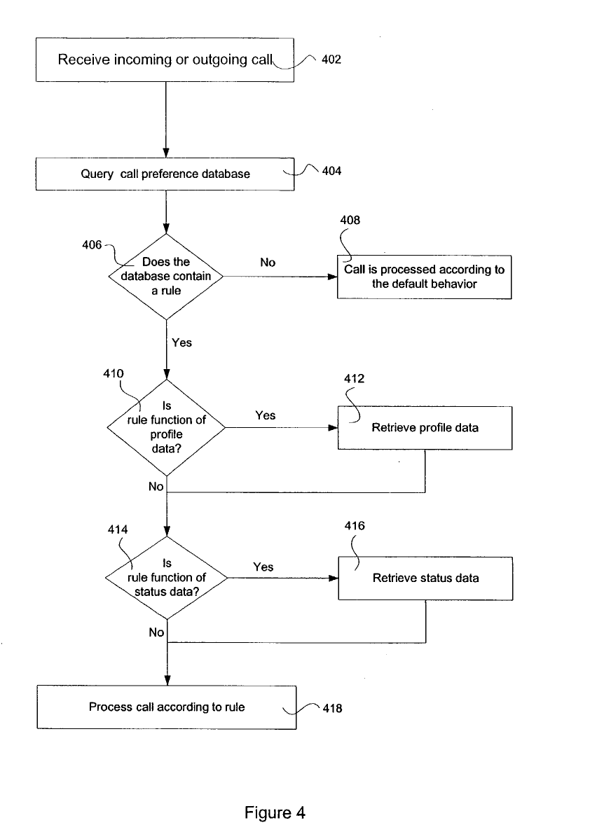

FIG. 4 illustrates a method that may be used by a call processing server to process calls in accordance with an embodiment of the invention. First, in step 402, a server receives an incoming or outgoing call. Next, in step 404, the server queries a call preference database. The query may seek any relevant call preference rules that are stored in the database. In step 406 it is determine whether or not the database contains at least one rule. When the database does not contain a rule, the call is processed according to the default behavior in step 408. When the database does contain a rule, in step 410 it is determined whether or not the rule is a function of profile data. When the role is a function of profile data, in step 412 the server retrieves profile data. The profile data may be stored in the user context database or within a mobile terminal.

Next, in step 414 it is determined whether or not the rule is a function of status data. When the rule is a function of status data, in step 416 status data is retrieved. The status data may be retrieved from a user context database or a mobile terminal. When the rule is not a function status or after step 416, the call is processed according to the rule(s) in step 418.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method of establishing call preference information for a mobile terminal, the method comprising:
(a) extracting application data from at least one software application;
(b) converting the application data into profile data; and
(c) transmitting the profile data to a context database.

2. The method of claim 1, further including:
(d) determining status data; and
(e) transmitting the status data to the context database.

3. The method of claim 1, wherein the context database is stored within the mobile terminal.

4. The method of claim 1, further including:
(d) creating at least one call preference rule that is a function of the profile data.

5. The method of claim 4, wherein the at least one call preference rule is also a function of status data.

6. The method of claim 5, wherein the status data comprises a type of network connected to the mobile terminal.

7. The method of claim 1, further including:
(e) transmitting the at least one call preference rule to a call preference database.

8. The method of claim 7, wherein (d) comprises creating the at least one call preference rule with a computer device.

9. The method of claim 8, wherein the computer device is configured to exchange the at least one call preference rule with the mobile terminal.

10. The method of claim 7, wherein (e) comprises transmitting the at least one call preference rule from the computer device to the call preference database via a wide area network.

11. The method of claim 1, wherein the application data comprises schedule data.

12. The method of claim 2, wherein the application data comprises location data.

13. The method of claim 1, wherein (b) comprises converting the application data into a profile data formatted in accordance with a profile data syntax.

14. A mobile terminal configured to establish call preference information, the mobile terminal comprising:
an application module that creates application data; and
a context profile management module that converts the application data into profile data formatted in accordance with a profile data syntax.

15. The mobile terminal of claim 14, further including:
a call preference module that allows a user to create at least one call preference rule that is a function of the profile data.

16. The mobile terminal of claim 15, wherein the call preference rule is also a function of status data.

17. The mobile terminal of claim 14 wherein the application data comprises schedule data.

18. The mobile terminal of claim 14 wherein the application data comprises location data.

19. A computer-readable medium containing computer-executable instructions for causing a mobile terminal to perform the steps comprising:
(a) extracting application data from at least one software application;
(b) converting the application data into profile data; and
(c) transmitting the profile data to a context database.
